(19) United States
(12) Patent Application Publication
(10) Pub. No.: US 2006/0183493 A1
(43) Pub. Date: Aug. 17, 2006

(54) Adaptive step size method for power control in wireless communication system and system for the same

(76) Inventors: Ni Ma, Shanghai (CN); Xuejun Zhang, Shanghai (CN); Jiang Cheng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,693

(22) PCT Filed: Dec. 29, 2003
(86) PCT No.: PCT/IB03/06250

§ 371 Date: Feb. 6, 2006

(30) Foreign Application Priority Data
Dec. 30, 2002 (CN) 02158392.7

(51) Int. Cl. H04B 7/00; H04Q 7/20

(52) U.S. Cl. 455/522

(57) ABSTRACT

The present invention relates to an adaptive step size method for power control in wireless communication systems and a system for the same. The method includes the steps: obtaining the power control information whose number is previously set in previous power control cycle and that in current power control cycle; Determining the power control step size in current power control cycle according to the obtained power control information whose number is previously set in previous power control cycle and that in current power control cycle. Employing the method to determine a suitable step size in current PC cycle, we can overcome the defect that the change of the PC step size in current wireless communication system is a fixed value, thereby make the power change more smooth, and ensure that wireless communication holds better communication quality.

### FIELD OF THE INVENTION

The invention generally relates to a system for power control in wireless communication system and a method for the same, and more particularly, to an adaptive step size system for power control in wireless communication system and a method for the same.

### BACKGROUND OF THE INVENTION

In the CDMA (Code Division Multiple Access) based wireless communication systems, the same carrier RF (Radio Frequency) is used to carry the different terminals' signal within one base station (BS), that is to say, within one BS, one same carrier RF can be used to carry many terminals to communicate. FIG. 1 is a schematic view of a communication between BS and terminals in general wireless communication system. As shown in FIG. 1, a general wireless communication system includes base station, base station controller, core network and mobile terminals. Communication between BS and mobile terminals is undertaken by means of a wireless resource (for example, a carrier RF in CDMA based communication system, and the two possible carriers RF or three ones in the third generation mobile communication system). In CDMA based communication system, the terminals located at the different spots use the same power to transmit the signals to the BS, whereas the received signals power level at the BS are different. Accordingly, the signal of the terminals near to the BS will suppress the signal of those far away from the BS. In order to overcome this so-called “near-far” effect, power control (PC) method is employed to keep the received signal power at the BS the same level. In wireless communication system, due to the existence of interference, an important parameter, Signal-to-Interference Noise Ratio (SINR) is commonly used to measure the received signal quality and be the criteria of PC.

The CDMA based wireless communication system generally involves two sorts of PC method, i.e. open-loop and closed-loop PC method. In the open-loop PC method, the terminal adjusts its transmission power only based on the measurement results within itself. While in the closed-loop PC method, both the BS and the terminal contribute to the power adjustment. On the other hand, the terminal adjusting its transmission power is named as uplink PC method, while at the same time the BS adjusting its transmission power is named as downlink PC method. We will focus on the uplink closed-loop PC method in the present invention. The said uplink closed-loop PC procedure can be subdivided into two processes which operate in parallel: outer-loop PC method and inner-loop PC method. The outer-loop PC procedure for the uplink operates within the BS and the network, and is responsible for setting a target for the received SINR from each terminal. This target is set on an individual basis for each terminal, according to the error rate of the decoded signal received from that terminal. The outer-loop PC adjusts the SINR target until the error rate meets the quality requirement for the received signal. The inner-loop PC mechanism controls the transmission power of the terminal in order to meet the SINR target at the BS set by the outer-loop.

Now, please refer to FIG. 2. FIG. 2 is a flow chart of the current PC. As showed from FIG. 2, the general procedures of the closed-loop uplink PC are as follows: Step S10. In every transmission time unit when the PC occurs (in TD-SCDMA system, this unit is sub-frame, in other systems such as IS-95 CDMA, W-CDMA and cdma2000, etc., this unit is time slot), the BS detects the received SINR (represented as SINR_{received}) of the terminal;

Step S20. The BS compares SINR_{received} with the target value (represented as SINR_{target}), which is set in the BS through the outer-loop PC;

Step S30. If SINR_{received}<SINR_{target,} the BS orders the terminal to increase its transmission power at step S30. If SINR_{received}>SINR_{target,} the BS sends an instruction to command the terminal to decrease its transmission power S32. If SINR_{received}=SINR_{target,} the BS instructs the terminal to keep its transmission power S33. The said terminals run the relevant operation (transmission power increasing S41, decreasing S42 or not changing S43) according to the instructions from the BS.

We call the above-mentioned Steps S10 to S30 as a PC cycle. Currently, the PC step size is constant, i.e., the terminal usually changes its transmission power by 1 dB in each PC cycle (or other constants defined by technical specification).

Considering such a constant PC step size, we can image that the SINR convergence to the target is slow, especially in the case of SINR_{received} far away from SINR_{target} so that the received signal quality at the BS is not so good during this phase. Moreover, the power change is still keeping fixed value even if SINR_{received} is very closed to SINR_{target}. Thus, the change thereof is not so smooth.

In order to improve PC performance, a flexible PC step size scheme has been proposed in 3GPP standard. In this way, a set of PC step size (0.5 dB, 1 dB or 2 dB, etc.) is pre-stored in the BS and the BS invokes the specific algorithm to select one from this set. Hence, in this scheme, the PC step size is still constant in a section of PC cycles.3

In the prior arts, there are many methods researching the PC in wireless communication system, for instance, some methods for PC are disclosed in the American patent US20020077138 and American patent US20020072385, etc. However, problems are all existed in respect of fixed PC step size change.

### SUMMARY OF THE INVENTION

The present invention therefore seeks to provide a non-fixed step size method for the PC. The method of the invention is used to determine a suitable step size for each PC cycle so as to make the SINR_{received} convergence quicker when far away from the target and make SINR_{received} more smooth when close to the target, and ensure that wireless communication holds better communication quality.

To achieve these objects and in accordance with the purpose of the present invention, there is an adaptive step size method for power control in wireless communication mobile terminal, it includes steps: Obtain the power control information whose number is previously set in previous power control cycle and that in current power control cycle; Determine the power control step size in current power control cycle according to the obtained power control information whose number is previously set in previous power control cycle and that in current power control cycle.

Another aspect of the present invention is to provide an adaptive step size method for power control in wireless communication system, it includes steps: Obtain the power control information whose number is previously set in previous power control cycle and that in current power control cycle; Determine the power control step size in current power control cycle according to the obtained power control information whose number is previously set in previous power control cycle and that in current power control cycle.

Another aspect of the present invention is to provide a wireless communication system, it includes an algorithm processing unit for PC, a memory unit, a signal processing unit, a receiving unit and a transmitting unit, wherein said memory unit used to store previous and current PC step size and PC attribute; said receiving unit receives the signal transmitted by the mobile terminal and sends SINR value of the signal to said algorithm processing unit for PC; said algorithm processing unit for PC compares SINR_{target} value with SINR_{received} value of the signal transmitted by the mobile terminal in order to determine the attribute of current PC step size and to detect the PC step size and PC attribute in previous PC cycle from the memory unit; if PC attributes in previous and current PC cycle increase or decrease continuously, then the PC step size in current PC cycle enlarges based on previous step size; if PC attributes in previous and current PC cycle increase or decrease discontinuously, then the PC step size in current PC cycle cuts down based on previous step size and the current PC step size and PC attribute are sent to the signal processing unit; said signal processing unit inserts current PC step size and PC attribute into the downlink transmitting signal and transmits them to the transmitting unit; the said transmitting unit transmits them to the mobile terminal.

Another aspect of the present invention is to provide a mobile terminal, it includes a transmitting unit, a receiving unit, a signal processing unit, a memory unit and an algorithm processing unit for power control, said receiving unit receives PC command from the BS and sends PC attribute to the algorithm processing unit for power control; said memory unit stores previous and current PC step size and PC attribute; said PC algorithm processing unit for PC detects current PC attribute and the PC step size and PC attribute in previous PC cycle from the memory unit, if PC attributes in previous and current PC cycle increase or decrease continuously, then the PC step size in current PC cycle enlarges based on previous step size; if PC attributes in previous and current PC cycle increase or decrease discontinuously, then the PC step size in current PC cycle cuts down based on previous step size and the current PC step size and PC attribute are sent to the signal processing unit. said signal processing unit adjusts terminal transmitters according to the received PC command; said transmitting unit transmits signals according to the adjusted transmitting power.

To sum up, the present invention provides a non-fixed step size method for the PC. The method of the present invention is used to determine a suitable step size for each PC cycle, which can overcome the defect that the change of the PC step size in current wireless communication system is a fixed value, thereby make the SINR_{received} convergence quicker when far away from the target; and when close to the target, the PC step size cuts down, thereby make SINR_{received} more smooth, and can ensure that wireless communication holds better communication quality.

### BRIEF DESCRIPTION OF THE DRAWINGS

The following will describe in detail the present invention with reference to the accompanying drawing figures wherein:

FIG. 1 is a schematic view of a communication between BS and terminals in general wireless communication system;

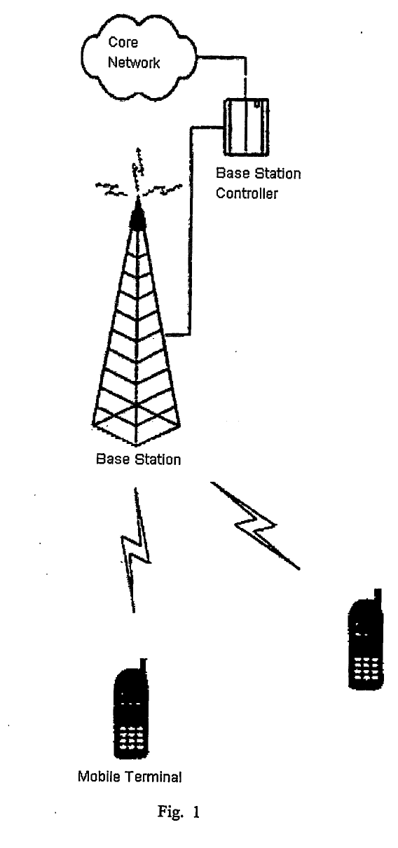

FIG. 2 is a flow chart of the conventional PC;

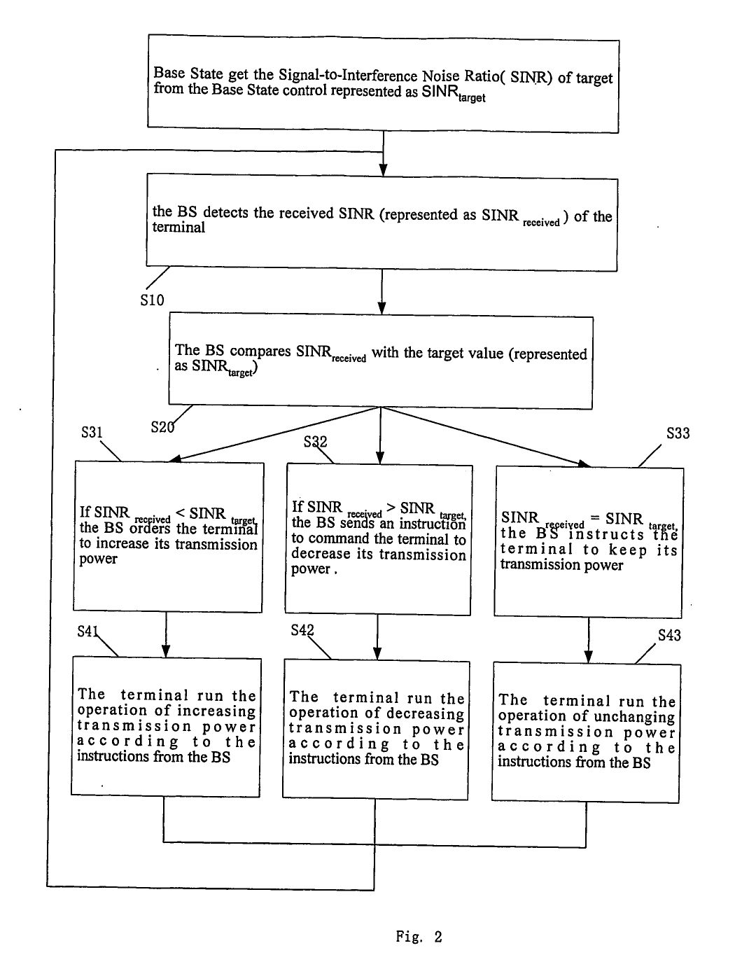

FIG. 3 is a flow chart of determining the step size method for PC of the invention;

FIG. 4 is a system block diagram of the memory unit and algorithm unit in the PC step size system of the invention locating at the BS; and

FIG. 5 is a system block diagram of the memory unit and algorithm unit in the PC step size system of the invention locating at the mobile terminal.

### DETAILED DESCRIPTION OF THE INVENTION

In the method of the present invention, we introduce an adaptive step size method for the power change. The main principle thereof is to employ the PC information in the previous n PC cycles and the known part of the PC information in the current PC cycle to jointly adjust the current PC step size so as to adapt to the change tendency of the step size.

We are to illustrate the embodiments of the present invention by taking examples. In this embodiment, we take n=1 as an example to describe our algorithm. However, the present invention is not limited to n=1. The said n can take any number, such as n=2, 3, or 4, etc. In this embodiment, as for the PC attribute denotation, let “+” stand for power increase while “−” stand for power decrease. That is, the step size and the attribute of the PC in the previous PC cycle together with the current PC attribute will be utilized to decide the current PC step size. This new method can be briefly figured as the following principles:
1. The current PC attribute is decided according to the comparison between SINR_{received} and SINR_{target} at the BS;
2. If the PC attributes in the previous one and current PC cycles are (++) or (−−), the PC step size in the current PC cycle enlarges based on the previous one step size;
3. If the PC attributes in the previous one and current PC cycles are (+−) or (−+), the PC step size in the current cycle cuts down based on the previous one step size;
4. The change value of each PC step size could also be various in each PC cycle conforming to the SINR convergent tendency.

Herein there is an example explaining our method. We use subscript previous and current to represent the previous one and current PC cycles respectively. In the above-mentioned scheme:

If PC Step Sizeₚᵣₑᵥᵢₒᵤₛ=1.0 dB and PC Attributeₚᵣₑᵥᵢₒᵤₛ=+, PC Attribute_{current}=+, then PC Step Size_{current}=1.1 dB; while

if PC Step Sizeₚᵣₑᵥᵢₒᵤₛ=1.0 dB and PC Attributeₚᵣₑᵥᵢₒᵤₛ=+, PC Attribute_{current}=−, then PC Step Size_{current}=0.9 dB;

wherein PC Attribute_{current} are decided by the comparison between SINR_{received} and SINR_{target}. In this example, the change value of each PC step size is assumed to be 0.1 dB. According to the fourth principle of the above method, this value could be different in each PC cycle but should be accord with the SINR convergent tendency.

To sum up, we employ an example that the current PC step size is determined by the combination of one previous PC step size value and PC attribute with current PC attribute. As above-mentioned, our method is not limited to employ one previous PC cycle step size and attribute. Our method can also employ several previous PC cycles step size and attribute combined with current PC attribute to determine the current PC step size. For instance, we take n=2, i.e. we use two previous PC cycles step size and attribute combined with current PC attribute to determine the current PC step size. As above-mentioned embodiment, we let “+” stand for power increase, while “−” stand for power decrease. Assumed that the PC attribute in the two previous PC cycles and current PC cycles is (+++) or (−−−), then the PC step size in the current PC cycle enlarges based upon the previous one step size. However, when adopting the above-mentioned three attributes to determine the current PC cycle step size, the PC increment is larger than that determined by adopting two attributes, for example, the increment is 0.2 dB. Assumed that the previous two PC cycles and PC attribute in current PC cycle is mixed, i.e. the attributes are not accord with, such as (+−+) or (−+−), etc., then the PC step size in the current PC cycle cuts down based on the previous one step size, as shown in the above-mentioned examples.

Due to timely tracking the change status of the PC step size, when the BS detects that the change of said PC step size increases continuously, the increase value of the PC step size can be increased properly in the next PC cycle so as to make the SINR reach the target quickly. Moreover, when close to the target, when the BS detects that the change of said PC step size decreases continuously, the decrease value of the PC step size can be decreased properly in the next PC cycle. Because the change value of the PC step size is decreased, the transmission power change in the present invention is much more smooth than that in the fixed PC step size.

We are to illustrate the above-mentioned method further by taking examples. The method that the PC step size in the current PC cycle is determined by the change trend of the PC step size in the previous n PC cycles is named as “constant value trend” method in the initially described examples of the invention. For example, in the following examples, if n=5, PC attribute is + or − continuously, the sequence number of the current PC cycle is 6:

PC_{step size 1}=0.5 dB, PC_{step size 2}=0.6 dB, PC_{step size 3}=0.7 dB, PC_{step size 4}=0.8 dB, PC_{step size 5}=0.9 dB, then PC_{step size 6}=1.0 dB in the current PC cycle. That is to say, the change value of the PC step size (represented as Δ, which is the same as the initial PC_{step size} set by the system) is fixed as 0.1 dB. The formula is as follows:
PC_{step size i}=PC_{step size i-1}±Δ(i=6, 5, 4, 3, 2).

Of course, we can adopt other “change value trend” methods. One scheme is “accelerated change”. The simple “accelerated change” can be represented as PC_{step size i}=PC_{step size i-1}+((i−1)×Δ) (i=6, 5, 4, 3, 2)

Namely, if PC_{step size 1}=0.5 dB, PC_{step size 2}=0.6 dB, PC_{step size 3}=0.8 dB, PC_{step size 4}=1.1 dB, PC_{step size 5}=1.5 dB, then PC_{step size 6}=2.0 dB.

Other “change value trend” methods exist, and here we do not want to illustrate them one by one. It should be pointed out that the main idea of the invention is to employ the PC information in the previous n PC cycles (mainly the change tendency of the PC step size) to adjust the current PC step size in the PC cycle. The present invention described two typical methods for determine the step size, however, it is not limited to them.

It should be pointed out that the change of the PC step size generally cannot be too large. If PC step is too large (for example 3dB or above), the communication quality during the period of the PC cycle will be influenced.

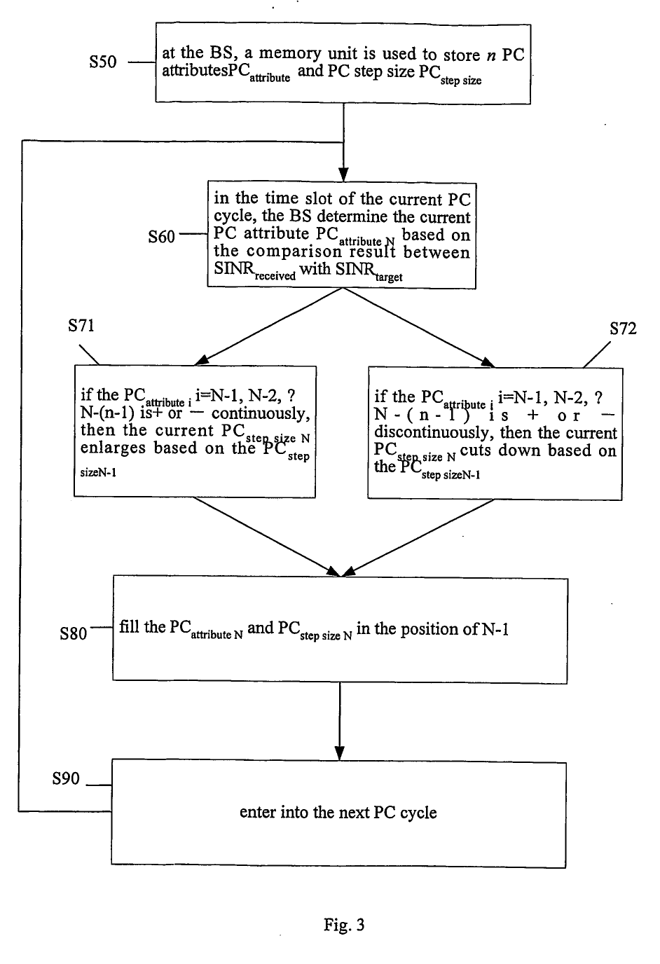

Now, with reference to FIG. 3, we are to illustrate the method of the present invention. In the flow chart, we still take the uplink PC as an example. First of all, at step S50, at the BS, a memory unit is used to store n PC attributes “PC_{attribute}” (i.e. the BS sends the command of increasing or decreasing the transmission power to the mobile terminal, represented as “+” or “−” respectively) and PC step size “PC_{step size}” (the value of the transmission power should be changed in the mobile terminal), and the numbers N, N−1, N−2, . . . , N−(n−1) stand for some current and previous PC cycles. Secondly, at step S60, in the time slot of the current PC cycle, the BS determine the current PC attribute “PC_{attribute N}” based on the comparison result between SINR_{received} with SINR_{target}. Afterwards at step S70, the PC step size in the current PC cycle is determined according to PC_{attribute N-1}, PC_{attribute N-2}, . . . , N PC_{attribute N-(n-}1) and corresponding PC_{step size N-1}, PC_{step size N-2}, . . . , PC_{step size N-(n-1)}, wherein, if the PC_{attribute i} (i=N−1, N−2, . . . , N−(n−1)) is “+” or “−” continuously, then the current PC_{step size N} enlarges based on the PC_{step sizeN-1}, at step S71; if the PC_{attribute i} (i=N−1, N−2, . . . , N−(n−1)) is “+” or “−” discontinuously, then the current PC_{step size N} cuts down based on the PC_{step sizeN-1}, at step S72; the change value of PC step size in every PC cycle can also be different according to the tendency of Signal Noise Ratio of the BS receiving the signal convergence to the SINR_{target}, at step S73. After accomplishing the above operation, shift the order of the “PC_{attribute}” and “PC_{step size}” in the BS memory unit backwards, and fill the “PC_{attribute N}” and “PC_{step size N}” in the position of N−1, at step S80. After this step, one PC cycle completes, then return to step S60 to enter into the next PC cycle, at step S90.

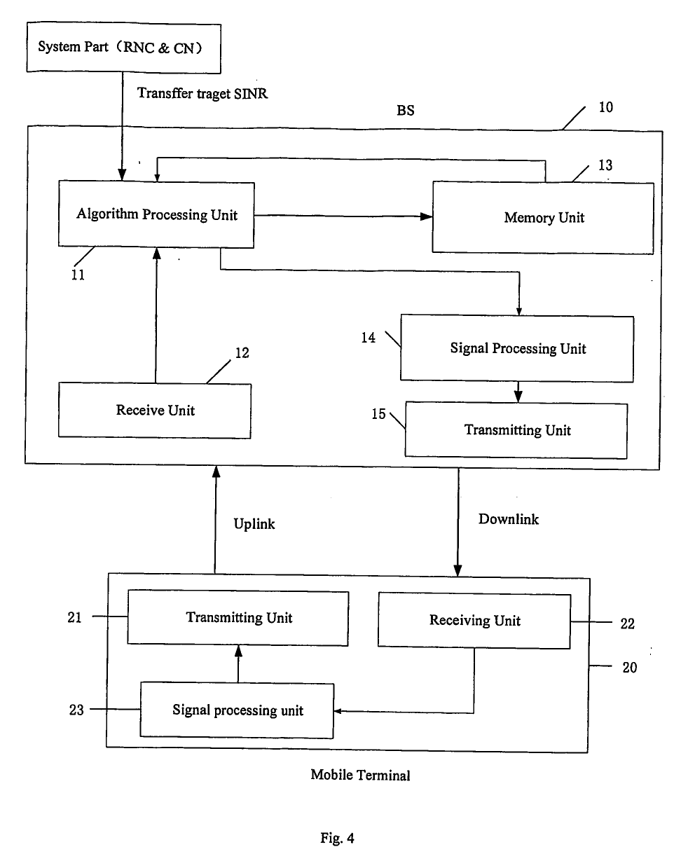

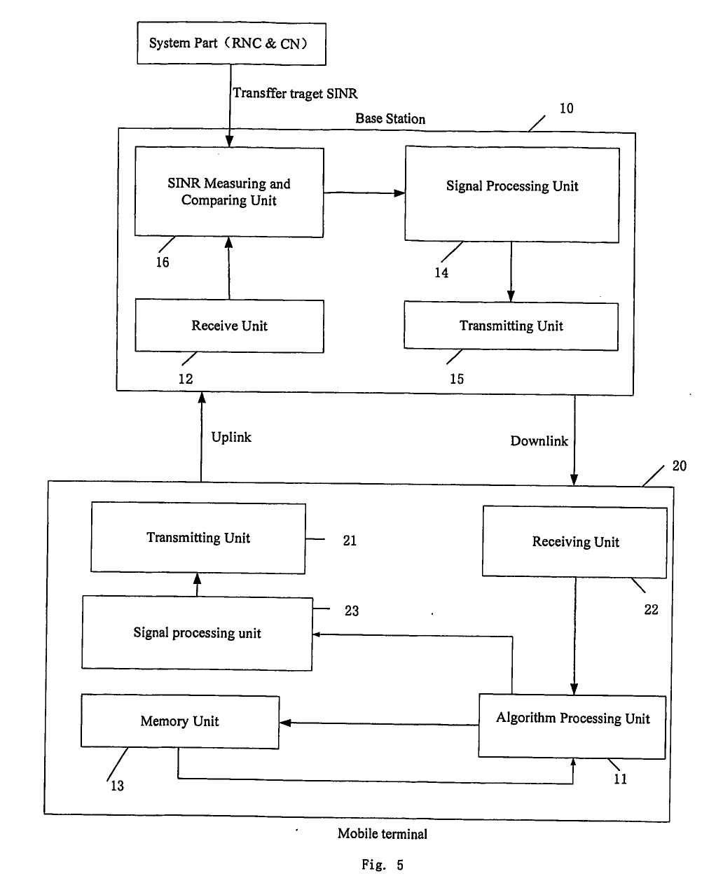

As for the equipment unit concerning the uplink closed-loop PC, two schemes can be chosen according to the present invention. One is to set the PC algorithm at the BS, after obtaining the PC step size and attribute, insert them into the BS downlink signal. And the mobile terminal only needs to adjust the transmitting power directly according to the received PC attribute and step size, as shown in FIG. 4. In this scheme, the memory unit for storing the PC attribute in the previous n PC cycles locates at the BS, and the algorithm processing also completes at the BS. The second one is that the BS just needs to transmit the PC attribute value, and the algorithm processing completes at the mobile terminal. Calculate the PC step size, then adjust the transmitting power, as shown in FIG. 5. In this scheme, the memory unit and algorithm processing unit locate at the terminal. That is to say, the method of the invention may accomplish at the BS or mobile terminal.

With reference to FIG. 4, we can see that, in order to accomplish the method of the present invention, PC system includes BS 10 and mobile terminal 20. The said BS at least includes PC algorithm processing unit 11., memory unit 13, signal processing unit 14, receiving unit 12 and transmitting unit 15. The said mobile terminal at least includes transmitting unit 21, receiving unit 22 and signal processing unit 23. In one PC cycle, PC algorithm processing unit 11 receives SINR target value from part of wireless communication network system, and receives SINR value of transmitting signal in the mobile terminal 20 received from the receiving unit 12, determine the current PC step size attribute, then receive the PC information in the previous PC cycle from the memory unit 13, for example PC step size and PC attribute. If PC attributes in previous and current PC cycle increase or decrease continuously, then the PC step size in current PC cycle enlarges based on previous step size; if attributes in previous and current PC cycle increase or decrease discontinuously, then the PC step size in current PC cycle cuts down based on previous step size. The said algorithm processing unit 11 sends the calculated PC step size and attribute in the current PC cycle to memory unit 13, and sends the PC step size and attribute to signal processing unit 14, and at the same time inserts them into downlink transmitting signal and transmits to the transmitting unit 15. Then the transmitting unit 15 transmits them to the mobile terminal 20. The receiving unit 22 of the said mobile terminal 20 receives PC command of the BS which includes PC step size and attribute, then the receiving unit 22 transmits the PC step size and attribute to the signal processing unit 23 of mobile terminal. The signal processing unit 23 adjusts terminal transmitters according to the received PC command. The transmitting unit 21 transmits signals to the BS 10 according to the adjusted transmitting power. Thus, one PC cycle is accomplished.

As shown in FIG. 5, if the memory unit 13 and algorithm processing unit 11 are placed at the mobile terminal 20, the method of the present invention can also be accomplished. The PC system includes BS 10 and mobile terminal 20. The said BS 10 at least includes SINR measuring and comparing unit 16, signal processing unit 14, receiving unit 12, and transmitting unit 15. The said mobile terminal 20 at least includes receiving unit 22, PC algorithm processing unit 11, memory unit 13, transmitting unit 21, and signal processing unit 23. In one PC cycle, the SINR measuring and comparing unit 16 receives SINR target value from the part of wireless communication network system, and receives SINR_{received} value of transmitting signal in the mobile terminal received from the receiving unit. Determine the current PC attribute. Then SINR measuring and comparing unit sends the current PC attribute to signal processing unit 14, and inserts it into downlink transmitting signal and transmits to the transmitting unit 15. Then the transmitting unit 15 transmits it to the mobile terminal 20. The receiving unit 22 of the said mobile terminal 20 receives PC command of the BS which includes PC attribute. Then the receiving unit 22 transmits the PC attribute to PC algorithm processing unit 11. The said unit receives the PC information in the previous PC cycle from the memory unit 13, for example PC step size and PC attribute. If PC attributes in previous and current PC cycle increase or decrease continuously, the PC step size in current PC cycle enlarges based on previous step size; if attributes in previous and current PC cycle increase or decrease discontinuously, the PC step size in current PC cycle cuts down based on previous step size. Then the said PC algorithm processing unit 11 sends the calculated PC step size and attribute in the current PC cycle to memory unit 13, and at the same time sends the current PC step size signal to signal processing unit 23 of the mobile terminal. The said signal processing unit 23 adjusts terminal transmitters according to the calculated PC information. The transmitting unit 21 transmits signals to the BS 10 according to the adjusted transmitting power. Thus, one PC cycle is accomplished.

It should be pointed out that, though the present invention is illustrated by aiming at wireless communication system based on CDMA, the method of the invention can be applied to all kinds of wireless communication systems requiring PC, such as GSM mobile communication system and AMPS mobile communication system.

While specific embodiments of the present invention have been shown and described, the foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

1. An adaptive step size method for power control in wireless communication mobile terminal, it includes steps:
Obtain the power control information whose number is previously set in previous power control cycle and that in current power control cycle;
Determine the power control step size in current power control cycle according to the obtained power control information whose number is previously set in previous power control cycle and that in current power control cycle.

2. The method according to claim 1, wherein said power control information whose number is previously set in previous power control cycle is PC_{attribute N-1}, PC_{attribute N-2}, . . . , PC_{attribute N-(n-1)} and corresponding PC_{step size N-1}, PC_{step size N-2}, . . . PC_{step size N-(n-1)}, the said power control information in current power control cycle is PC_{attribute N}, and the said current PC step size is PC_{step size N}.

3. The method according to claim 2, further including the following steps:
If current PC_{attribute} and previous PC_{attribute} whose number is set increase or decrease continuously, the current PC_{step size N} enlarges based on PC_{step size N-1;}
If current PC_{attribute} and previous PC_{attribute} whose number is set increase or decrease discontinuously, the current PC_{step size N} cuts down based on PC_{step size N-1}.

4. The method according to claim 3, wherein said current PC_{attribute} is determined by base station according to the comparison results of SINR_{received} with SINR_{target}.

5. The method according to claim 1, wherein the change value of the PC step size in the said current PC cycle can be determined according to the tendency of the change value of the PC step size of transmitting power whose number is previously set.

6. The method according to claim 1, wherein said PC method can be applied to uplink closed-loop PC or downlink closed-loop PC.

7. The method according to claim 6, wherein said power control method can be applied to wireless communication system based on CDMA, wireless communication system based on GSM and AMPS mobile communication system.

8. The method according to claim 1, further including the following steps:
Store PC_{attribute} whose number is set in previous PC cycle and corresponding PC_{step size} whose number is set in the memory unit; and
Store current PC_{attribute} and PC_{step size} into the memory unit in order to determine the PC_{step size} in the next PC cycle.

9. An adaptive step size method for power control in wireless communication system, it includes steps:
Obtain the power control information whose number is previously set in previous power control cycle and that in current power control cycle;
Determine the power control step size in current power control cycle according to the obtained power control information whose number is previously set in previous power control cycle and that in current power control cycle.

10. The method according to claim 9, wherein said power control information whose number is set in previous power control cycle is PC_{attribute N-1}, PC_{attribute N-2}, . . . , PC_{attribute N-(n-1)} and corresponding PC_{step size N-1}, PC_{step size N-2}, . . . , PC_{step size N-(n-1)}, the PC attribute in the said current power control is PC_{attribute N}, and the said current PC step size is PC_{step size N}.

11. The method according to claim 9, further including the following steps:
If current PC_{attribute} and previous PC_{attribute} whose number is set increase or decrease continuously, the current PC_{step size N} enlarges based on PC_{step size N-1};
If current PC_{attribute} and previous PC_{attribute} whose number is set increase or decrease discontinuously, the current PC_{step size N} Cuts down based on PC_{step size N-1}.

12. A wireless communication system, it includes an algorithm processing unit for PC, a memory unit, a signal processing unit, a receiving unit and a transmitting unit, wherein
said memory unit used to store previous and current PC step size and PC attribute;
said receiving unit receives the signal transmitted by the mobile terminal and sends SINR value of the signal to said algorithm processing unit for PC;
said algorithm processing unit for PC compares SINR_{target} value with SINR_{received} value of the signal transmitted by the mobile terminal in order to determine the attribute of current PC step size and to detect the PC step size and PC attribute in previous PC cycle from the memory unit; if PC attributes in previous and current PC cycle increase or decrease continuously, then the PC step size in current PC cycle enlarges based on previous step size; if PC attributes in previous and current PC cycle increase or decrease discontinuously, then the PC step size in current PC cycle cuts down based on previous step size and the current PC step size and PC attribute are sent to the signal processing unit;
said signal processing unit inserts current PC step size and PC attribute into the downlink transmitting signal and transmits them to the transmitting unit;
said transmitting unit transmits them to the mobile terminal.

13. A mobile terminal, it includes a transmitting unit, a receiving unit, a signal processing unit, a memory unit and an algorithm processing unit for power control,
said receiving unit receives PC command from the BS and sends PC attribute to the algorithm processing unit for power control;
said memory unit stores previous and current PC step size and PC attribute;
said PC algorithm processing unit for PC detects current PC attribute and the PC step size and PC attribute in previous PC cycle from the memory unit, if PC attributes in previous and current PC cycle increase or decrease continuously, then the PC step size in current PC cycle enlarges based on previous step size; if PC attributes in previous and current PC cycle increase or decrease discontinuously, then the PC step size in current PC cycle cuts down based on previous step size and the current PC step size and PC attribute are sent to the signal processing unit.
said signal processing unit adjusts terminal transmitters according to the received PC command;
said transmitting unit transmits signals according to the adjusted transmitting power.
